(19) United States
(12) Patent Application Publication
(10) Pub. No.: US 2026/0034976 A1
(43) Pub. Date: Feb. 5, 2026

(54) SYSTEMS AND METHODS FOR CONTROL OF HYDROGEN SYSTEMS

(71) Applicant: Cummins Inc., Columbus, IN (US)

(72) Inventors: Jennifer Kay Light-Holets, Greenwood, IN (US); Aaron William Beinborn, Greenwood, IN (US)

(73) Assignee: Cummins Inc., Columbus, IN (US)

(21) Appl. No.: 19/279,606

(22) Filed: Jul. 24, 2025

Related U.S. Application Data
(60) Provisional application No. 63/679,063, filed on Aug. 2, 2024.

(51) Int. Cl. B60W 20/12; B60W 10/06; B60W 10/26; B60W 20/13

(52) U.S. Cl. CPC B60W 20/12; B60W 10/06; B60W 10/26; B60W 20/13; B60W 2510/244; B60W 2520/04; B60W 2555/20; B60W 2555/60; B60W 2710/0616; B60W 2710/244

(57) ABSTRACT

A system includes a controller having at least one processor coupled to at least one memory device storing instructions that, when executed by the at least one processor, cause the controller to perform operations. The operations include receiving a first indication of a hydrogen limiting condition corresponding to a geographic area. The operations include, responsive to the hydrogen storage value being at or above a hydrogen storage threshold, comparing a predicted state of charge of a battery of the system to a state of charge threshold. The operations include causing a hydrogen combustion engine to consume at least a portion of the hydrogen fuel such that the hydrogen storage value decreases responsive to the predicted state of charge being at or above the state of charge threshold.

### CROSS-REFERENCE TO RELATED APPLICATION

This U.S. Patent Application claims the benefit and priority to U.S. Provisional Application No. 63/679,063, filed Aug. 2, 2024, which is incorporated herein by reference in its entirety and for all purposes.

### FIELD

The present disclosure relates to systems and methods for control of hydrogen systems. The hydrogen systems can include a hydrogen-fueled internal combustion engine system.

### BACKGROUND

A hydrogen-fueled internal combustion engine consumes hydrogen fuel to produce power (e.g., for turning a crankshaft of a system embodying the engine, such as a vehicle). Unlike internal combustion engines that burn carbonaceous fuel, such as diesel fuel or gasoline, the exhaust produced by a hydrogen internal combustion engine may not include hydrocarbons or carbon oxides (e.g., carbon monoxide or carbon dioxide). Rather, the exhaust may include sulfur oxides (SOx) originating from burning lubricants, nitrogen oxides (NOx) originating from burning the hydrogen fuel in the presence of air (including nitrogen, N2, and oxygen, O2), and/or water (H2O) originating from burning the hydrogen fuel in the presence of air (including oxygen, O2) or from the presence of water (e.g., humidity) in the intake air. The exhaust may also include unconsumed hydrogen (H2).

### SUMMARY

One embodiment relates to a system. The system includes a controller having at least one processor coupled to at least one memory device storing instructions that, when executed by the at least one processor, cause the controller to perform operations. The operations include: receiving a first indication of a hydrogen limiting condition corresponding to a first geographic area; comparing a hydrogen storage value of a hydrogen storage system to a hydrogen storage threshold, the hydrogen storage system configured to store hydrogen fuel; responsive to the hydrogen storage value being at or above the hydrogen storage threshold, comparing a predicted state of charge of a battery of the system to a state of charge threshold; and causing a hydrogen combustion engine to consume at least a portion of the hydrogen fuel such that the hydrogen storage value decreases responsive to the predicted state of charge being at or above the state of charge threshold.

Another embodiment relates to a method. The method includes receiving an indication of a hydrogen production condition; comparing a hydrogen storage value to a hydrogen storage threshold; and responsive to the hydrogen storage value being below the hydrogen storage threshold and responsive to receiving the hydrogen production condition, causing a hydrogen production system to produce hydrogen fuel. The hydrogen production system is on a vehicle.

Still another embodiment relates to a hydrogen engine system. The hydrogen engine system includes a controller having a communications interface and at least one processor coupled to at least one memory device storing instructions that, when executed by the at least one processor, cause the controller to perform operations. The operations include receiving, via the communications interface, a first indication of a hydrogen limiting condition corresponding to a first geographic area; comparing a hydrogen storage value of a hydrogen storage system to a hydrogen storage threshold, the hydrogen storage system configured to store hydrogen fuel; comparing a fuel storage value of a fuel storage system to a fuel storage threshold; and causing a dual-fuel combustion engine to consume at least a portion of the hydrogen fuel whereby the hydrogen storage value decreases, responsive to determining that the hydrogen storage value is at or above the hydrogen storage threshold and that the fuel storage value is at or above the fuel storage threshold.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION

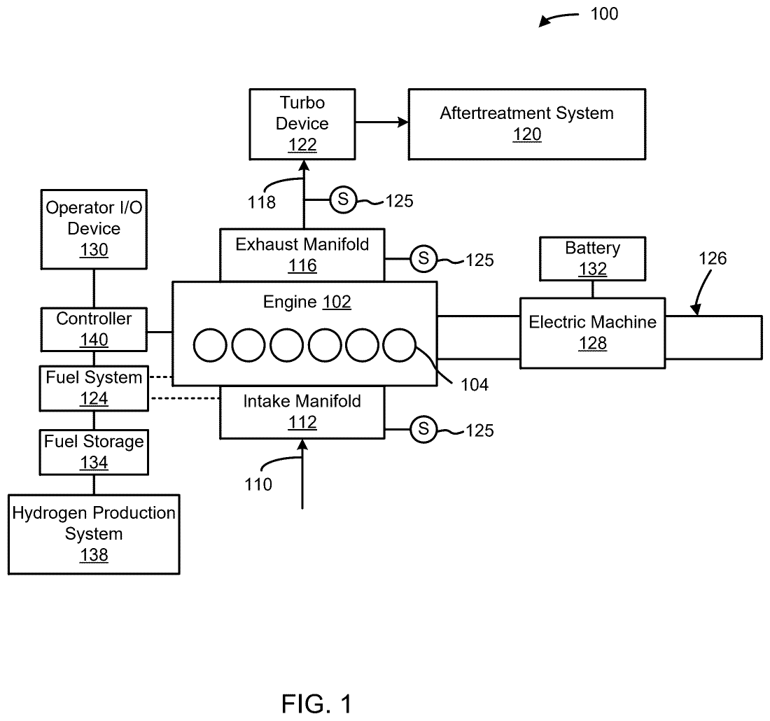

FIG. 1 is a block diagram of a system including a hydrogen-fueled internal combustion engine system, according to an example embodiment.

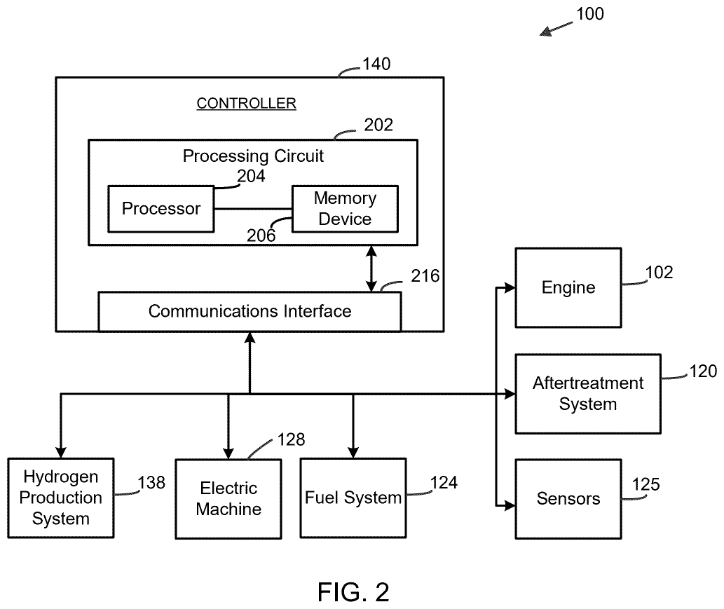

FIG. 2 is a block diagram of a controller of the system of FIG. 1, according to an example embodiment.

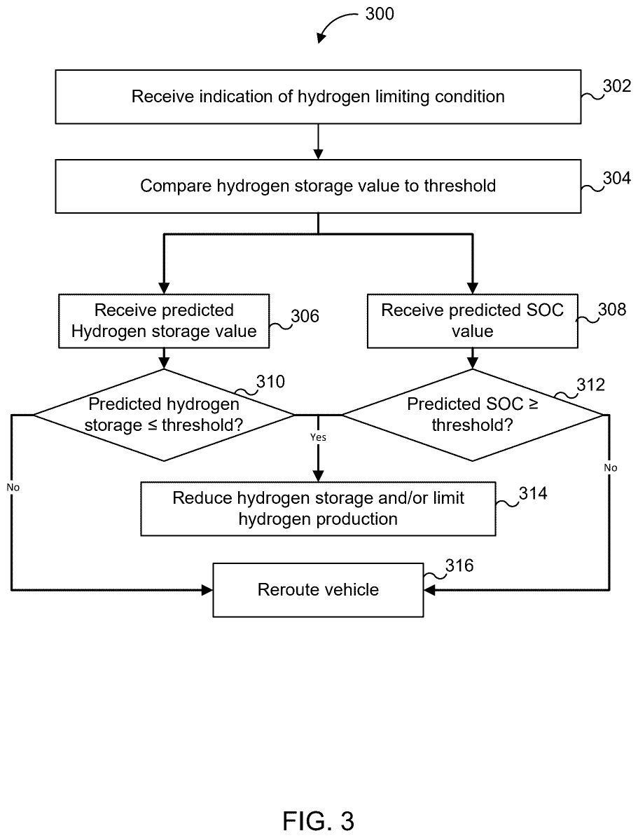

FIG. 3 is a flow diagram of a method of controlling the system of FIG. 1, according to an example embodiment.

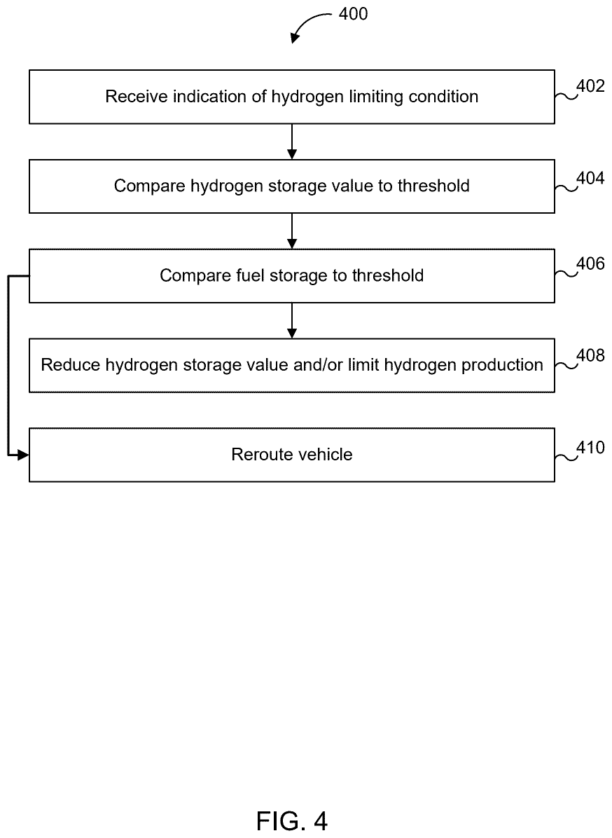

FIG. 4 is a flow diagram of a method of controlling the system of FIG. 1, according to another example embodiment.

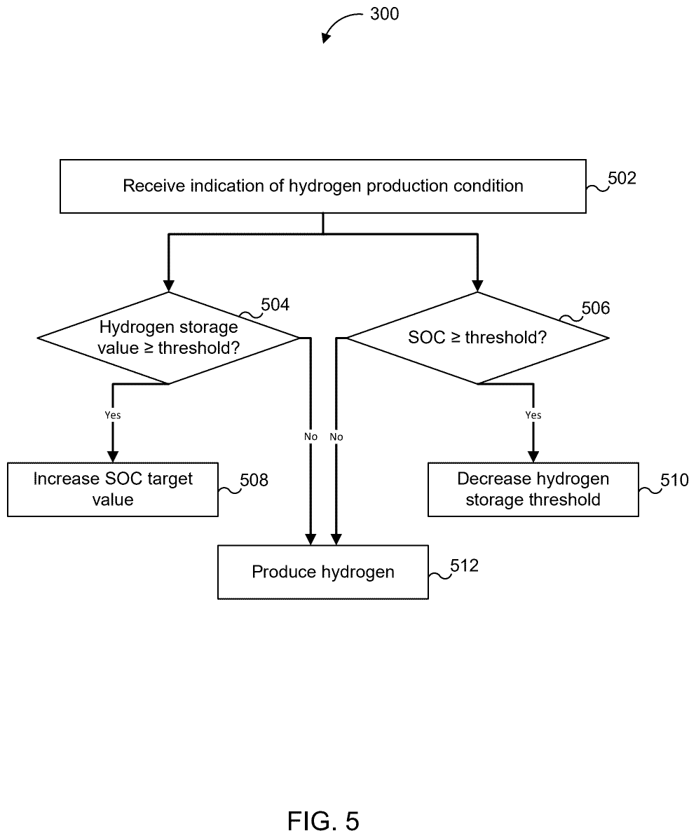

FIG. 5 is a flow diagram of a method of controlling the system of FIG. 1, according to yet another example embodiment.

### DETAILED DESCRIPTION

Following below are more detailed descriptions of various concepts related to, and implementations of, methods, apparatuses, computer-readable media, and systems for control of a hydrogen-fueled internal combustion engine system. Various embodiments described herein relate to mitigating (e.g., reducing) increased hydrogen content in or proximate the engine system. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As utilized herein, the term “estimating” and like terms are used to refer to determining an approximate current or past value based on data (e.g., sensor data, historical sensor data, real-time sensor data, etc.), which may be close but not necessarily exactly the actual value of the determined current or past parameter value. In some embodiments, estimating the current or past value can be performed using one or more models (e.g., statistical models, artificial intelligence models, machine learning models, etc.). For example, estimating hydrogen content can include using data, such as sensor data, with a model to determine the hydrogen content. As utilized herein, the term “measuring” and like terms are used to refer to determining an approximate current or past parameter value based on detecting or receiving information regarding the parameter (e.g., using a sensor). The measured value may be close but not necessarily exactly the actual value of the measured current or past parameter value. As utilized herein, the term “predicting” and like terms are used to refer to determining an approximate future value based on current and/or past information (e.g., sensor data, historical sensor data, real-time sensor data, etc.), which may be close but not necessarily exactly the actual value of the determined future parameter value. In some embodiments, predicting the future value can be performed using one or more models (e.g., statistical models, artificial intelligence models, machine learning models, etc.). For example, predicting hydrogen content can include using data, such as sensor data, with a model to determine the future hydrogen content.

As utilized herein, the term “operational data” and like terms are used to refer to data regarding the operation of a system, such as an engine system. In some embodiments, operational data may include settings, values, or other information regarding the operation of a system. In some embodiments, the operational data may be measured (e.g., by one or more real sensors), estimated (e.g., by one or more virtual sensors or by a computer device or processing circuit), and/or otherwise determined based on a target value.

As utilized herein, the term “content” and like terms may refer to a characteristic of substance, such as a part of a mixture. For example, the content or content value may include an amount (e.g., absolute amount, a relative amount, etc.) of the substance within the mixture. The amount may be expressed as a value, such as a mass value (e.g., measured in grams, kilograms, etc.), a weigh value (e.g., measured in ounces, pounds, etc.), or another suitable value, such as a molar value. In some embodiments, the amount may be expressed as a concentration (e.g., an amount of a substance divided by the total amount of a mixture), such as parts per million, percent weight, percent mass, molar concentration, volumetric concentration, and so on. For example, the hydrogen content in a gas stream may be a mass of the hydrogen, a concentration of hydrogen relative to the gas stream, a percentage of hydrogen by weight relative to the weight of the gas stream, etc. In another example, the water content in a gas stream may be a mass of the water, a concentration of water relative to the gas stream, a percentage of water by weight relative to the gas stream, etc.

As described herein, an engine system may include an engine and an exhaust aftertreatment system in exhaust gas receiving communication with the engine. The exhaust aftertreatment system may include one or more components, such as a particulate filter configured to remove particulate matter from exhaust gas flowing in the exhaust gas conduit system, a dosing module (e.g., a doser) configured to supply a dosing fluid to the exhaust gas flowing in the aftertreatment system, and one or more catalyst devices configured to facilitate conversion of the exhaust gas constituents (e.g., nitrogen oxides, NOₓ, sulfur oxides, SOₓ, etc.) to less harmful elements (e.g., water, nitrogen, N₂, etc.), such as an oxidation catalyst, a selectively catalytic reduction (SCR) system, a three-way catalyst, and so on.

As described herein, the engine system may include a hydrogen generation/production system configured to produce hydrogen fuel (e.g., hydrogen gas). The hydrogen production system may include one or more components, such as an electrolyzer, configured to convert water into hydrogen gas (e.g., via electrolysis).

Advantageously, a control system or controller of the system may control the operation of the engine system and/or the hydrogen production system to selectively reduce an amount of hydrogen gas in or proximate the engine system. For example, the controller may cause the engine system to combust at least a portion of the hydrogen gas, to reduce the amount of hydrogen stored by a hydrogen storage device (e.g., a hydrogen storage tank). In another example, the controller may control the operation of the hydrogen production system by deactivating the hydrogen production system, such that hydrogen is not produced.

In some embodiments, the control system or controller may monitor one or more parameters of the components of the engine system using one or more sensors (e.g., actual sensors and/or virtual sensors) to collect and/or determine sensor data. For example, the sensor data may include a hydrogen content at or proximate one or more components of the engine system. In some embodiments, the control system may compare sensor data to one or more thresholds to determine whether to reduce the amount of hydrogen stored by a hydrogen storage device. In some embodiments, the control system may reduce the amount of hydrogen stored by a hydrogen storage device based on receiving a particular input, such as an engine shutdown request or other information regarding a work schedule of the engine system. As described herein, a “work schedule” of an engine system refers to one or more periods of time during which the engine system is used to generate power. In various embodiments information regarding a work schedule may include one or more of a working duration (e.g., a duration of at least one period of time during which the engine is used to generate power), a work start time (e.g., a time of day the working duration begins), a work end time (e.g., a time of day the working duration ends), information regarding the work schedule (e.g., min./max. power output during the work period, etc.), and so on. In various embodiments, information regarding a work schedule may include location information related to the work schedule, such as a starting location, a destination, a route between the starting location and the destination, and so on. In some embodiments, the control system may reduce the amount of hydrogen stored by a hydrogen storage device based on receiving a location of the engine system, such as the current location of the engine system, a route of the engine system, and so on.

As described herein, it may be desirable to reduce the amount of hydrogen stored by a hydrogen storage device and/or reduce the amount of hydrogen produced by a hydrogen production system. Hydrogen gas in an engine system (e.g., in a cylinder, or, more specifically, in a combustion chamber, in a crankcase, etc.) or proximate an engine system can oxidize with oxygen in the atmosphere. That is, with respect to hydrogen-fueled internal combustion engines, hydrogen (e.g., unburned H₂) in or proximate the engine system may become flammable due its high combustibility characteristic. Thus, it may be desirable to reduce the amount of hydrogen stored by a hydrogen storage device and/or reduce the amount of hydrogen produced by a hydrogen production system to mitigate thermal events associated with hydrogen gas.

In an example operating implementation, the control system (e.g., a controller, a vehicle controller, etc.) receives an indication of a “hydrogen limiting condition.” The “hydrogen limiting condition” may be associated with a predetermined environment (e.g., a tunnel, a city center, a loading dock, proximity or distance to certain buildings, such as schools, etc., and so on), a predetermined geographic area (e.g., a region, a city, etc.), or other location where a hydrogen production value and/or a hydrogen storage value may be limited or regulated (e.g., by a government entity, a regulatory body, a business goal, etc.). The control system may selectively reduce the amount of hydrogen stored by a hydrogen storage device and/or selectively reduce the amount of hydrogen produced by a hydrogen production system, responsive to receiving the hydrogen limiting condition. These and other features and benefits are described more fully herein below.

Referring now to FIG. 1, a schematic view of a block diagram of a system 100 is shown, according to an example embodiment. The engine system 100 includes an engine 102 and an aftertreatment system 120 in exhaust gas receiving communication with the engine 102. The system 100 includes a controller 140 (as shown in FIG. 2) and an operator input/output (I/O) device 130, where the controller 140 is coupled, particularly communicably coupled, to each of the aforementioned components.

In some embodiments, the engine system 100 includes a turbo device 122 disposed between the engine 102 and the aftertreatment system 120, such that the turbo device 122 is in exhaust gas receiving communication with the engine 102 and exhaust gas providing communication with the aftertreatment system 120. In these embodiments, the aftertreatment system 120 is in exhaust gas receiving communication with the engine 102 (e.g., via the turbo device 122).

In the configuration of FIG. 1, the engine system 100 is included in a vehicle. The vehicle may be any type of on-road or off-road vehicle including, but not limited to, wheel-loaders, fork-lift trucks, line-haul trucks, mid-range trucks (e.g., pick-up trucks, etc.), sedans, coupes, tanks, airplanes, boats, and any other type of vehicle. In another embodiment, the engine system 100 may be embodied in a stationary piece of equipment, such as a power generator or genset. All such variations are intended to fall within the scope of the present disclosure.

In the configuration shown in FIG. 1, the engine 102 is a hydrogen internal combustion engine (ICE). The hydrogen ICE may consume hydrogen fuel to generate power. In some embodiments, the engine 102 may be part of a hybrid engine system having a combination of an internal combustion engine and at least one electric machine coupled to at least one battery. For example, as shown in FIG. 1, the engine system 100 may include an electric machine 128 (e.g., a motor, a motor generator, an electric starter, an eAxle, etc.) that is coupled to the engine 102 via a shaft (e.g., an output shaft, a drive shaft, a crankshaft, etc.). In some embodiments, the engine system 100 may be configured as a mild-hybrid powertrain, a parallel hybrid powertrain, a series hybrid powertrain, or a series-parallel powertrain. In some embodiments, the engine 102 may be or include a dual-fuel engine configured to consume hydrogen fuel and another type of fuel, such as diesel, natural gas, biodiesel, landfill gas, biogas, and so on.

The engine 102 includes one or more cylinders 104 (e.g., combustion cylinders). The cylinders 104 are disposed within a combustion chamber of the engine 102. In some embodiments, the engine 102 includes six cylinders 104. However, it should be understood that the engine 102 may include more or fewer cylinders 104 (e.g., at least one) than as shown in FIG. 1. Furthermore, the cylinders 104 may be provided in varying arrangements (e.g., in-line, horizontal, V, or other suitable cylinder arrangement).

The engine system 100 includes an intake conduit 110 and an intake manifold 112. The intake conduit 110 is configured to route an intake gas stream, including air (e.g., ambient air, compressed air, etc.), to the intake manifold 112. The intake manifold 112 is configured to route the intake gas stream from an intake conduit 110 into the engine 102. More specifically, the intake manifold 112 is configured to route air from the intake conduit 110 to each of the cylinders 104.

The engine system 100 includes an exhaust manifold 116 and an exhaust conduit 118. The exhaust manifold 116 is configured to route an exhaust gas stream from the engine 102 to the exhaust conduit 118. More specifically, the exhaust manifold 116 is configured to route an exhaust gas stream from each of the cylinders 104 to the exhaust conduit 118. The exhaust conduit 118 is configured to route the exhaust gas stream from the exhaust manifold 116 to a downstream component, such as the aftertreatment system 120 and/or the turbo device 122. In some embodiments, a first portion of the exhaust conduit 118 is disposed between the exhaust manifold 116 and turbo device 122. The first portion of the exhaust conduit 118 is configured to route the exhaust gas stream from the exhaust manifold 116 to turbo device 122. In some embodiments, a second portion of the exhaust conduit 118 is positioned between the aftertreatment system 120 and the turbo device 122. The second portion of the exhaust conduit 118 is configured to route the exhaust gas stream from the turbo device 122 to the aftertreatment system 120.

The aftertreatment system 120 is in exhaust gas receiving communication with the engine 102. The aftertreatment system 120 includes components used to reduce exhaust emissions, such as a selective catalytic reduction (SCR) catalyst, an oxidation catalyst (OC), a particulate filter (PF), an exhaust fluid doser with a supply of exhaust fluid, a plurality of sensors for monitoring the aftertreatment system (e.g., a nitrogen oxide (NOx) sensor, temperature sensors, etc.), and/or still other components.

The turbo device 122 may be any type of turbo machinery, such as a turbocharger, a variable geometry turbocharger, a power turbine, etc. The turbo device 122 may be operatively coupled to the engine 102 and/or another component of the engine system 100, such as a drivetrain, a battery, an electric machine, or other suitable components. In some embodiments, the turbo device 122 is configured to compress a gas stream (e.g., an intake gas stream, an exhaust gas stream, etc.) and provide the compressed gas stream to the engine 102. For example, as shown in FIG. 1, the turbo device 122 may be coupled to the intake manifold 112 such that the turbo device is operative to provide the compressed gas stream to the engine 102 (e.g., via the intake manifold 112).

The engine system 100 also includes a fuel system 124. The fuel system 124 is configured to provide fuel (e.g., hydrogen) to the engine 102. More specifically, the fuel system 124 is configured to provide fuel to each of the one or more cylinders 104 (e.g., via one or more fuel injectors). The fuel system 124 may include or be coupled to one or more components for providing the fuel to the engine 102, such as a storage tank for storing the fuel, and/or one or more regulators (e.g., valves, solenoids, etc.) for controlling an amount or timing of fuel provided to the engine 102. For example, the fuel system 124 may be coupled to a fuel storage device 134. The fuel storage device 134 may be or include a fuel storage tank (e.g., a hydrogen storage tank).

In embodiments where the engine 102 is or includes a dual-fuel engine, the fuel system 124 is configured to provide both hydrogen and another type of fuel to the engine 102. Additionally, the fuel storage device 134 may include both a hydrogen storage tank and another fuel storage tank.

In some embodiments, the controller 140 is operatively coupled to the fuel system 124, such that the controller 140 may control the operation of the fuel system 124. More specifically, the controller 140 may control the fuel system 124 to control an amount and/or timing of fuel provided to the engine 102.

As shown, a plurality of sensors 125 are included in the engine system 100. The number, placement, and type of sensors included in the engine system 100 is shown for example purposes only. That is, in other configurations, the number, placement, and type of sensors may differ. The sensors 125 may be gas constituent sensors (e.g., NOₓ sensors, oxygen sensors, H₂O/humidity sensors, hydrogen sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. The gas constituent sensors may include a hydrogen sensor that is structured to acquire data indicative of the presence of hydrogen at or proximate the sensor 125, such as in a gas stream (e.g., a hydrogen content of the gas stream) and/or in a storage device, such as the fuel storage device 134.

As shown in FIG. 1, the sensors 125 may be located at or proximate the intake conduit 110, the intake manifold 112, the exhaust manifold 116, the exhaust conduit 118, and/or the aftertreatment system 120. For example, the engine system 100 may include sensors 125 located both before and after the aftertreatment system 120. It should be understood that the location of the sensors may vary, and the system 100 may include more or fewer sensors than as shown in FIG. 1.

Additional sensors may be also included with the system 100. The sensors may include engine-related sensors (e.g., torque sensors, speed sensors, pressure sensors, flowrate sensors, temperature sensors, etc.). The sensors may further include sensors associated with other components of the vehicle, such as the aftertreatment system 120, the turbo device 122, the fuel system 124, the fuel storage device 134, etc. For example, the sensor may include a speed sensor of the turbo device 122, a fuel quantity and injection rate sensor, a fuel rail pressure sensor, etc.).

The sensors 125 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of the speed of the engine 102 (typically expressed in revolutions per minute). The sensor is coupled to the engine (when structured as a real sensor) and is structured to send a signal to the controller 140 indicative of the speed of the engine 102. When structured as a virtual sensor, at least one input may be used by the controller 140 in an algorithm, model, lookup table, etc. to determine or estimate a parameter of the engine (e.g., power output, etc.). Any of the sensors 125 described herein may be real or virtual.

The controller 140 is coupled, and particularly communicably coupled, to the sensors 125. Accordingly, the controller 140 is structured to receive data from one or more of the sensors 125 and provide instructions/information to the one or more sensors 125. The controller 140 may control one or more components in the system 100 based on the received data.

As briefly described above, the engine system 100 includes a shaft 126 (e.g., an output shaft, a drive shaft, a crankshaft, etc.). The shaft 126 is configured to transmit power output by the engine 102 to another component, such as an axle, a wheel, or another shaft. In some embodiments an intermediate component couples the engine 102 to the shaft 126, such as a clutch, a transmission, etc.

In some embodiments, the engine system 100 includes an electric machine (e.g., a generator, a motor, a motor generator, etc.) shown as an electric machine 128. The electric machine 128 is configured to use electrical power (e.g., from a battery or an alternator) to output mechanical power. For example, the electric machine 128 is coupled to the shaft 126 such that the shaft 126 is operable to receive power output by the electric machine 128. In some embodiments, the electric machine 128 is coupled to the engine 102 (e.g., via the shaft 126) such that the electric machine 128 is operable to rotate the engine 102.

In some embodiments, the system 100 includes a battery 132. The battery 132 is coupled to the electric machine 128, such that the electric machine 128 is operable to receive power from and/or provide power to the battery 132. In some embodiments, the battery is coupled to the engine 102 (e.g., via the shaft 126 and the electric machine 128). In an example embodiment, the battery 132 is coupled to the controller 140 and is configured to provide information regarding a status of the battery to the controller 140. For example, the battery 132 may provide a state of charge (SOC) to the controller 140.

In some embodiments, the system 100 includes a hydrogen generation/production system 138. The hydrogen production system 138 is configured to produce hydrogen gas. For example, the hydrogen production system 138 may be or include an electrolyzer that is configured to convert water into hydrogen gas and oxygen gas. The hydrogen production system 138 is coupled to the fuel storage device 134, such that the hydrogen production system 138 is operable to provide the produced hydrogen gas to the fuel storage device 134. In some embodiments, the hydrogen production system 138 is coupled to the controller 140, such that the controller 140 is operable to control the hydrogen production system 138. For example, the controller 140 may activate, deactivate, or adjust the operation of the hydrogen production system 138. In particular, the controller 140 may cause the hydrogen production system 138 to produce a predefined amount of hydrogen. Additionally, the controller 140 may prevent the hydrogen production system 138 from producing hydrogen.

The operator input/output (I/O) device 130 may be coupled to the controller 140, such that information may be exchanged between the controller 140 and the I/O device, where the information may relate to one or more components of FIG. 1 or determinations (described below) of the controller 140. The operator I/O device enables an operator of the system 100 to communicate with the controller 140 and one or more components of the system 100 of FIG. 1. For example, the operator input/output device may include, but is not limited to, an interactive display, a touchscreen device, one or more buttons and switches, voice command receivers, etc. In this way, the operator input/output device may provide one or more indications or notifications to an operator, such as a malfunction indicator lamp (MIL), etc. Additionally, the vehicle may include a port that enables the controller 140 to connect or couple to a scan tool so that fault codes and other information regarding the vehicle may be obtained.

The controller 140 is structured to control, at least partly, the operation of the system 100 and associated sub-systems, such as the engine 102 and the operator I/O device 130. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1. The structure and function of the controller 140 is further described in regard to FIG. 2.

As the components of FIG. 1 are shown to be embodied in the system 100, the controller 140 may be structured as one or more electronic control units (ECUs), such as one or more microcontrollers. The controller 140 may be separate from or included with at least one of a transmission control unit, an exhaust aftertreatment control unit, a powertrain control module, an engine control unit, an engine control module, etc.

Now referring to FIG. 2, a schematic diagram of the controller 140 of the system 100 of FIG. 1 is shown, according to an example embodiment. As shown, the controller 140 includes at least one processing circuit 202 having at least one processor 204 and at least one memory device 206, and a communications interface 216. The processing circuit 202 may be structured or configured to execute or implement the instructions, commands, and/or control processes described herein. The controller 140 is structured to facilitate purging fluid from the engine 102 and/or the aftertreatment system 120. In some embodiments, the fluid is water that entered the system 100 from the ambient air or that was produced by combusting hydrogen in the presence of air (or, more specifically, oxygen). In some embodiments, the fluid is hydrogen gas. The hydrogen may enter the engine 102 from the fuel system 124. The hydrogen may enter the aftertreatment system 120 as exhaust from the engine 102 (e.g., when the hydrogen is not combusted by the engine 102. Specific processes for purging fluid from the engine 102 and/or the aftertreatment system 120 are described herein below.

The at least one processor 204 may be implemented as one or more single-or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the at least one processing circuit 202 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 206 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 206 may include dynamic random-access memory (DRAM). The memory device 206 may be communicably connected to the processor 204 to provide computer code or instructions to the processor 204 for executing at least some of the processes described herein. Moreover, the memory device 206 may be or include tangible, non-transient volatile memory or non-volatile memory. Accordingly, the memory device 206 may include database components, object code components, script components, or any other type of information structure for supporting the various activities and information structures described herein.

The communications interface 216 may include any combination of wired and/or wireless interfaces (e.g., jacks, antennas, transmitters, receivers, transceivers, wire terminals) for conducting data communications with various systems, devices, or networks structured to enable in-vehicle/system communications (e.g., between and among the components of the vehicle when the system is embodied or included in the vehicle) and out-of-vehicle/system communications (e.g., with a remote server). For example, and regarding out-of-vehicle/system communications, the communications interface 216 may include an Ethernet card and port for sending and receiving data via an Ethernet-based communications network and/or a Wi-Fi transceiver for communicating via a wireless communications network. The communications interface 216 may be structured to communicate via local area networks or wide area networks (e.g., the Internet) and may use a variety of communications protocols (e.g., IP, LON, Bluetooth, ZigBee, radio, cellular, near field communication).

As shown in FIG. 2, the communications interface 216 may enable communication with the engine 102, the aftertreatment system 120 (and/or a component thereof), the one or more sensors 125, the fuel system 124, and/or the hydrogen production system 138. In some embodiments, the communications interface 216 may enable communication with the electric machine 128.

The controller 140 is structured to enable operation of the engine 102. For example, during operation, the controller 140 may receive one or more user inputs (e.g., via the operator I/O device 130) such as a user pressing an accelerator, a user pressing a brake, or other suitable user input. In operation, the controller 140 may control (e.g., increase, decrease, or maintain) an amount of fuel (e.g., hydrogen) provided to the engine 102 by selectively controlling one or more components of the fuel system 124.

The controller 140 is structured to enable operation of the electric machine 128. For example, the controller 140 may selectively cause the electric machine 128 to receive power from the engine 102 (e.g., via the shaft 126) and cause the electric machine 128 to convert the received power into electrical power. The electrical power may be used to power one or more electrical devices of the system 100, such as one or more heaters, one or more compressors, one or more fans, and so on. The electrical power may be used to charge the battery 132. The controller 140 may selectively cause the electric machine 128 to provide power to the shaft 126 (e.g., to rotate the shaft 126). For example, the controller 140 may cause the electric machine 128 to receive electrical power from the battery 132 and used the received electrical power to rotate the shaft 126 (e.g., to propel a vehicle associated with the system 100).

The controller 140 is structured to enable operation of the hydrogen production system 138. For example, the controller 140 may control (e.g., increase, decrease, or maintain) an amount of hydrogen produced by the hydrogen production system 138. In some embodiments, the controller 140 may control the hydrogen production system 138 to produce a predefined amount of hydrogen (e.g., in mass or volume). In some embodiments, the controller 140 may control the hydrogen production system 138 to produce a predefined amount of hydrogen over a predefined period of time (e.g., a rate of hydrogen production in mass and/or volume per unit time). In any of these embodiments, the controller 140 may set a target hydrogen production value (e.g., an amount of hydrogen and/or a rate of hydrogen production) and cause the hydrogen production system 138 to produce hydrogen according to the target hydrogen production value.

In some embodiments, when the hydrogen production system 138 is producing hydrogen at the target hydrogen production value, the amount of fuel stored in the fuel storage device 134 (referred to herein as a “fuel storage value”) may change based on a current rate of hydrogen consumption by the engine 102. When the target hydrogen production value (e.g., the rate of hydrogen production) is above the rate of hydrogen consumption by the engine 102, the amount of hydrogen stored at the fuel storage device 134 may increase. When the target hydrogen production value is below the rate of hydrogen consumption by the engine 102, the amount of hydrogen stored at the fuel storage device 134 may decrease. When the target hydrogen production value is substantially equal to (e.g., within 10%, within 5%, within 1%, etc.) the rate of hydrogen consumption by the engine 102, the amount of hydrogen stored at the fuel storage device 134 may remain substantially constant (e.g., increasing or decreasing by less than 10%, less than 5%, less than 1%, etc.).

In some embodiments, the controller 140 is configured to receive a fuel storage value. In some embodiments, the controller 140 receives the fuel storage value from a sensor 125 associated with the fuel storage device 134.

In some embodiments, the controller 140 is configured to control the engine 102, the electric machine 128, and/or the hydrogen production system 138 based on receiving or identifying a hydrogen limiting condition. In some embodiments, the hydrogen limiting condition is based on a current or potential future location of the system 100. For example, the controller 140 may receive location information regarding the system 100, such as a global positioning system (GPS) location information, route information, etc. In some embodiments, the controller 140 may determine a current location of the system 100 based on the received location information. In some embodiments, the controller 140 may determine a future location of the system 100 (e.g., based on the route information). When the current location or the future location of the system 100 is in a predetermined environment (e.g., a tunnel, a city center, a loading dock, proximity or distance to certain buildings, such as schools, etc., a storage location of the system 100, such as a warehouse, a barn, etc., and so on), a predetermined geographic area (e.g., a region, a city, etc.), or other location where a hydrogen production value and/or a hydrogen storage value may be limited or regulated (e.g., by a government entity, a regulatory body, a business goal, etc.), the controller 140 may receive the hydrogen limiting condition. Or, when the information associated with the hydrogen limiting condition is determined (e.g., the system 100 is in the predetermined geographic area, environment, etc.), the controller 140 may determine, identify, or otherwise activate the hydrogen limiting condition to control the engine 102, the electric machine 128, and/or the hydrogen production system 138.

In some embodiments, the hydrogen limiting condition is received based on traffic information regarding the route of the system 100. For example, the controller 140 may receive information regarding traffic conditions along the route of the system 100. The controller 140 may receive the hydrogen limiting condition responsive to determining that the traffic conditions indicate a vehicle speed value at or below a predetermined threshold.

In some embodiments, the hydrogen limiting condition is received based on a payload associated with the system 100. For example, the controller 140 may receive information regarding a payload associated with the system 100, such as a payload material type (e.g., the chemical composition of the payload). In some embodiments, the controller 140 may receive the hydrogen limiting condition responsive to determining that the payload material type includes a material that is reactive with hydrogen, such as oxygen. In some embodiments, the controller 140 may receive the hydrogen limiting condition responsive to determining that the payload material type includes a material that is flammable.

In some embodiments, the hydrogen limiting condition is received based on a current time of day. For example, the controller 140 may receive the hydrogen limiting condition during predetermined hours of the day (e.g., between 5 PM and 5 AM, between 5 PM and 9 AM, between 12 AM and 5 AM, and so on).

In some embodiments, the hydrogen limiting condition is received based on ambient weather conditions proximate the system 100 and/or proximate the route of the system 100. For example, the controller 140 may receive information regarding the ambient weather conditions proximate the system 100 and/or proximate the route of the system 100. The controller 140 may receive the hydrogen limiting condition responsive to determining that the ambient weather conditions indicate one or more of a wind speed value at or below a predetermined threshold, an ambient temperature value at or above a predetermined threshold, etc.

In some embodiments, the hydrogen limiting condition is received via the communications interface 216. The controller 140 may receive a signal from a remote computing device (e.g., a device remote to the system 100) regarding the hydrogen limiting condition via the communications interface 216. For example, the remote computing device may be associated with a geographic area or environment where the hydrogen production value and/or the hydrogen storage value is limited or regulated. The controller 140 may receive the signal form the remote computing device responsive to the controller 140 establishing wireless communication with the remote computing device (e.g., via the communications interface 216) and/or responsive to the controller 140 being within a predetermined distance of the remote computing device.

In some embodiments, the hydrogen limiting condition is received or determined responsive to determining (e.g., by the controller 140) that a hydrogen content value is at or above a hydrogen content threshold. For example, the controller 140 may receive a hydrogen content value from one or more sensors 125. In some embodiments, the hydrogen content value is indicative of an amount of hydrogen in or proximate the system 100. For example, the one or more sensors 125 may acquire data regarding a hydrogen content in or proximate the system 100. In some embodiments, the data regarding the hydrogen content in the system 100 includes a hydrogen content the engine 102 or a portion thereof, such as a crankcase of the engine 102. In some embodiments, the data regarding the hydrogen content proximate the system 100 includes a hydrogen content proximate a vehicle embodying the system 100 (e.g., within a predetermined distance of the vehicle, such as within 10 feet, within 5 feet, etc.).

In some embodiments, the controller 140 may prevent (or reduce the amount of) produced hydrogen by the hydrogen production system 138 (e.g., by reducing the target hydrogen production value, or setting the target hydrogen production value to zero) based on receiving or determining the hydrogen limiting condition. For example, the controller 140 may receive an indication of a hydrogen limiting condition corresponding to a first geographic area that the system 100 is in or will be in (e.g., based on the current location or future location of the system 100), such as a tunnel, a city center, a loading dock, proximity or distance to certain buildings, such as schools, etc. The controller 140 may cause the hydrogen production system 138 to decrease the amount of hydrogen produced (e.g., from a first value to a second value, less than the first value), responsive to receiving the hydrogen limiting condition.

In some embodiments, when the engine 102 is included in a hybrid engine system 100, the controller 140 may cause the engine 102 to charge the battery 132. In particular, the controller 140 may cause the engine 102 to produce excess power (e.g., more power than is required to operate the system 100) and cause the electric machine 128 to convert at least a portion of the excess power into electrical energy. The electrical energy may be used to charge the battery 132. To produce the excess power, the engine 102 may consume hydrogen at an increased rate relative to the increased/excess power being commanded by the controller 140. In some embodiments, the controller 140 may maintain or decrease the target hydrogen production value before the system 100 enters the first geographic area or is within the first geographic area, such that the hydrogen storage value decreases (e.g., from a first value to a second value, less than the first value and/or until the hydrogen storage value is at or below a first hydrogen storage threshold or until the system 100 exits the first geographic area). In some embodiments, the controller 140 may cause the engine 102 to produce excess power (e.g., to charge the battery 132) until the hydrogen storage value is at or below the first hydrogen storage threshold.

In some embodiments, the first hydrogen storage threshold is determined based on a fuel storage value being limited or regulated (e.g., by a government entity, a regulatory body, a business goal, etc.). For example, a maximum fuel storage value may be set to a particular value by a government entity, a regulatory body, a business goal, or another entity. The first hydrogen storage threshold may be equal to or less than the maximum fuel storage value. As described above, the maximum fuel storage value may be associated with first geographic area.

In some embodiments, the controller 140 may cause the engine 102 to produce excess power until a state of charge of the battery 132 is at or above a predefined state of charge threshold. In some embodiments, the SOC threshold is based on an estimated amount of charge required to traverse the first geographic area using the electric machine 128. For example, the controller 140 may estimate an amount of charge (measured in percentage of battery charge, kilowatt hours, etc.) that will be consumed by the electric machine 128 to propel a vehicle embodying the system 100 through the first geographic area (e.g., along the route of the system 100). The estimated amount of charge may be determined based on a lookup table or model that correlates the distance traveled by the system 100 with battery charge consumed by the electric machine 128.

In some embodiments, when the engine 102 is included in a parallel hybrid engine system 100, the controller 140 may adjust a “power split” between the engine 102 and the electric machine 128. As described herein a “power split” refers to an amount of power output by the engine 102 (e.g., to rotate the shaft 126) and an amount of power output the electric machine 128 (e.g., to rotate the shaft 126). The power split may be expressed as a ratio or percentage of the amount of power output by the engine 102 relative to the amount of power output the electric machine 128. Thus, the power split may be defined by two values: a first value indicative of the absolute or relative amount of power output by the engine 102 and a second value indicative of the absolute or relative amount of power output by the electric machine 128. For example, when the amount of power output by the engine 102 is equal to the amount of power output the electric machine 128, the power split is “50%-50%.” In another example, when only the electric machine 128 is outputting power, the power split is “0%-100%.” In yet another example, when only the engine 102 is outputting power, the power split is “100%-0%.” In other embodiments, the power split may include a single value that represents the amount of power output by the engine 102 relative to the amount of power output the electric machine 128, such as a ratio or a percentage. For example, when the amount of power output by the engine 102 is equal to the amount of power output the electric machine 128, the power split is “50%.” In another example, when only the electric machine 128 is outputting power, the power split is “0%.” In yet another example, when only the engine 102 is outputting power, the power split is “100%.”

The controller 140 is configured to alter the power split between the engine 102 and the electric machine 128 responsive to receiving the hydrogen limiting condition, such as before entering the first geographic area. For example, the controller 140 is configured to alter the power split between the engine 102 and the electric machine 128 such that the engine 102 outputs relatively more power before the system 100 enters the first geographic area. In another example, the controller 140 is also configured to alter the power split between the engine 102 and the electric machine 128 such that the electric machine 128 outputs relatively more power when the system 100 is within the first geographic area. In some embodiments, the controller 140 also maintains or decreases the target hydrogen production value before the system 100 enters the first geographic area or is within the first geographic area, such that the hydrogen storage value decreases (e.g., from a first value to a second value, less than the first value and/or until the hydrogen storage value is at or below the first hydrogen storage threshold or until the system 100 exits the first geographic area).

As described above, in some embodiments, the hydrogen limiting condition may correspond to a geographic area along the route of the system 100. Decreasing the hydrogen storage value below the first hydrogen storage threshold may allow the system 100 to travel within the geographic area along the route. In some embodiments, the route including the geographic area associated with the hydrogen limiting condition along the route may be a relatively more advantageous route (e.g., a shorter route, a less expensive route having fewer tolls, and so on). Thus, decreasing the hydrogen storage value below the first hydrogen storage threshold may advantageously allow the system 100 to travel along the route.

In some embodiments, when the hydrogen storage value is at or above the first hydrogen storage threshold or will likely be above the threshold when the system 100 enters the first geographic area and the SOC of the battery 132 is below the SOC threshold or will likely be below the threshold when the system 100 enters the first geographic area, the controller 140 may generate a new route for the vehicle embodying the system 100, responsive to receiving the hydrogen limiting condition.

In some embodiments, controller 140 is configured to determine whether the hydrogen storage value will likely be above the threshold when the system 100 enters the first geographic area. For example, the controller 140 may use one or more of a lookup table or a model (e.g., a statical model, a machine learning model, etc.) that correlates (i) an amount of excess power that the engine 102 is capable of generating (e.g., based on a current engine 102 power output and a maximum engine 102 power output) before the system 100 enters the first geographic area and/or (ii) an amount of power the battery 132 can absorb (e.g., based on a current SOC of the battery 132, a charging rate of the battery 132, and the amount of excess power that the engine 102 is capable of generating) with a predicted amount of hydrogen fuel consumed to generate the excess power. The predicted amount of hydrogen fuel consumed to generate the excess power may correspond to the hydrogen storage value when the when the system 100 enters the first geographic area (e.g., a “predicted hydrogen storage value”). The predicted hydrogen storage value is the current hydrogen storage value minus the predicted amount of hydrogen fuel consumed to generate the excess power. The controller 140 may determine that the hydrogen storage value will likely be above the threshold when the system 100 enters the first geographic area responsive to the predicted hydrogen storage value being above the first hydrogen storage threshold.

In some embodiments, controller 140 is configured to determine whether the SOC of the battery 132 will likely be below the threshold when the system 100 enters the first geographic area. For example, the controller 140 may use one or more of a lookup table or a model (e.g., a statical model, a machine learning model, etc.) that correlates an amount of excess power that the engine 102 is capable of generating (e.g., based on a current engine 102 power output and a maximum engine 102 power output) before the system 100 enters the first geographic area with a predicted amount of power provided to the battery 132 using the excess power. The predicted amount of power provided to the battery 132 may correspond to a SOC of the battery when the system 100 enters the first geographic area (e.g., a “predicted SOC value”). The predicted SOC value is the current SOC plus the predicted amount of power provided to the battery 132. The controller 140 may determine that the SOC of the battery 132 will likely be below the threshold when the system 100 enters the first geographic area responsive to determining that the predicted SOC value is less than the SOC threshold.

In some embodiments, when the hydrogen storage value is at or above the hydrogen storage threshold or will likely be above the hydrogen storage threshold and the state of charge is below the state of charge threshold or will likely be below the state of charge threshold, the system 100 may not be able to reduce the hydrogen storage value below the first hydrogen storage threshold and/or the system 100 may not be able to produce enough excess energy to charge the battery 132 above the SOC threshold. In either case, it may be undesirable to allow the system 100 to enter the first geographic area. For example, when the hydrogen storage value is at or above the first hydrogen storage threshold, it may be undesirable for the system 100 to enter the first geographic area because of a restriction or regulation on hydrogen storage within the first geographic area. In another example, when the SOC of the battery 132 is below the SOC threshold and/or will likely be below the SOC threshold, battery 132 may not have enough stored power for consumption by the electric machine 128 to traverse the first geographic area. For example, the SOC threshold may correspond to a first “range” of the system 100 (e.g., 1 mile, 10 miles, etc.). As described herein, a “range” of an electric or hybrid system 100 refers to the distance the system 100 can travel before the SOC of the battery 132 is at or below a predetermined threshold. The first range of the system 100 associated with the SOC threshold may be is at or above a distance along the route of the system 100 within the first geographic area. When the SOC of the battery 132 is below the SOC threshold, the range of the system 100 may be less than the distance along the route of the system 100 within the first geographic area, such that the system 100 cannot traverse the first geographic area using only the electric machine 128.

The controller 140 may generate the new route responsive to determining that the SOC of the battery 132 will likely be below the threshold when the system 100 enters the first geographic area. The new route may correspond to a second geographic area, different than the first geographic area. The second geographic area may not correspond to a hydrogen limiting condition. In some embodiments, the controller 140 may reduce the hydrogen storage value responsive to determining that the SOC of the battery 132 will likely be at or above the SOC threshold when the system 100 enters the first geographic area responsive to determining that the current SOC of the battery 132 plus the predicted increase in the SOC of the battery 132 is at or above the SOC threshold.

In some embodiments, responsive to receiving the hydrogen limiting condition, the controller 140 may decrease the hydrogen storage value (e.g., from a first value to a second value, less than the first value). In some embodiments, the controller 140 may decrease the hydrogen storage value by causing the engine 102 to produce excess power. As described above, the excess power may be used to charge the battery 132. In some embodiments, however, when the SOC of the battery 132 is at or above a SOC threshold (e.g., 80%, 100%), the controller 140 may cause the engine 102 to produce excess power without using the excess power. For example, the controller 140 may cause the engine 102 to decouple from the shaft 126, such that the excess power is wasted (e.g., not used to power another device of the system 100). In some embodiments, the controller 140 may decrease the hydrogen storage value by causing the fuel storage device 134 to release the hydrogen into the atmosphere.

In some embodiments, the controller 140 may cause the hydrogen production system 138 to produce hydrogen at a rate that matches the current hydrogen consumption rate of the engine 102, based on receiving the hydrogen limiting condition. For example, the controller 140 may set the hydrogen production value or, more specifically, the rate of hydrogen production, to be equal to the hydrogen consumption rate of the engine 102. In some embodiments, the hydrogen consumption rate of the engine 102 may change over time. In some embodiments, the controller 140 may update the hydrogen production value to be equal to the hydrogen consumption rate of the engine 102 in real time (e.g., ever second, every millisecond, etc.). In some embodiments, the controller 140 may update the hydrogen production value to be equal to an average hydrogen consumption rate of the engine 102 over a predefined time period (e.g., one minute, one hour, etc.). In any of the above-described embodiments, setting the hydrogen production value to be equal to the hydrogen consumption rate of the engine 102 (or the average hydrogen consumption rate of the engine 102) may substantially prevent the hydrogen storage value from increasing.

In some embodiments, the controller 140 is configured to control the engine 102, the electric machine 128, and/or the hydrogen production system 138 based on receiving a hydrogen production condition. In some embodiments, the hydrogen production condition is based on a current or future location of the system 100. For example, the controller 140 may receive location information regarding the system 100, such as a global positioning system (GPS) location information, route information, etc. In some embodiments, the controller 140 may determine a current location of the system 100 based on the received and/or determined location information. In some embodiments, the controller 140 may determine a future location of the system 100 (e.g., based on the route information). When the current location or the future location of the system 100 is in a predetermined environment (e.g., on a highway, at a refueling location, at a resting location, at a delivery location, etc.), a predetermined geographic area (e.g., a region, a rural area, a predetermined distance away from a city, etc.), or other location where a hydrogen production value and/or a hydrogen storage value is not limited or regulated (e.g., by a government entity, a regulatory body, a business goal, etc.), the controller 140 may receive or determine the hydrogen production condition.

In some embodiments, the controller 140 may cause the hydrogen production system 138 to produce hydrogen responsive to receiving the hydrogen production condition. In some embodiments, the controller 140 may cause the hydrogen production system 138 to produce hydrogen responsive to receiving the hydrogen production condition and responsive to determining that the fuel storage value is at or below a second hydrogen storage threshold.

In some embodiments, the second hydrogen storage threshold is based on a “mission” of the system 100. As described herein, a “mission” of the system 100 refers to an expected output of a system 100 during a predefined time period. The predefined time period may be or include a time period that extends from a current time into the future. In some embodiments, the controller 140 may receive information regarding the mission of the system 100. The information regarding the mission can include a distance traveled by the system 100 during the mission, a route traveled by the system 100 during the mission, indications of hydrogen production conditions during the mission and/or indications of hydrogen limiting conditions during the mission. In an example embodiment, the second hydrogen storage threshold is based on the distance traveled by the system 100. For example, the second hydrogen storage threshold may be a fuel storage value associated with an amount of fuel required by the engine 102 to propel the system 100 the distance of the mission, or a segment thereof.

In some embodiments, second hydrogen storage threshold is based on a target SOC of the battery 132. For example, the second hydrogen storage threshold may be a hydrogen storage value associated with an amount of fuel required by the engine 102 to produce enough power to raise the SOC of the battery 132 at or above the target SOC.

In some embodiments, the target SOC is based on the mission of the system 100. For example, the target SOC may be an amount of charge required by the electric machine 128 to propel the system 100 the distance of the mission.

In some embodiments, the target SOC is based on an upcoming hydrogen limiting condition (e.g., a hydrogen limiting condition along a future portion of the route of the system 100). For example, the target SOC may be an amount of charge required by the electric machine 128 to propel the system 100 through or out of the geographic area associated with an upcoming hydrogen limiting condition. When the vehicle enters the geographic area associated with the hydrogen limiting condition, the SOC of the battery 132 is at or above the target SOC. Additionally, when the vehicle enters the geographic area associated with the hydrogen limiting condition, the hydrogen storage value is at or below the first hydrogen storage threshold because, for example, the controller 140 implemented one or more of the above-described controls regarding the hydrogen limiting condition. Beneficially, when the vehicle enters the geographic area associated with the hydrogen limiting condition, additional hydrogen production is not needed for operating the system 100 (e.g., because the electric machine 128 may generate power using the power stored by the battery 132 rather than the engine 102 consuming fuel to generate power).

In some embodiments, the controller 140 may increase the target SOC of the battery 132 (e.g., from a first value to a second value, greater than the first value). In some embodiments, the controller 140 may increase the target SOC of the battery 132, responsive to receiving the hydrogen production condition. In some embodiments, increasing the target SOC of the battery 132 increases an amount of charge received during a “charge event.” As described herein, a “charge event” refers to a period of time, during which, the battery 132 receives power from a power source external to the system 100, such as a charging station, a plug-in charger, a wireless charger, and so on. For example, during a charge event, the battery 132 may be coupled to a charging station (e.g., via a wired connection or a wireless connection) and receive power from the charging station. In some embodiments, increasing the target SOC of the battery 132 increases an amount of power received by the battery 132 from the engine 102 during or before a hydrogen limiting condition. For example, as described above, during or before hydrogen limiting condition, the controller 140 may cause the engine 102 to produce excess power and provide the excess power to the battery 132 (e.g., via the shaft 126 and/or the electric machine 128). In this way, increasing the target SOC of the battery 132 may beneficially decrease the amount of hydrogen stored at the fuel storage device 134 by causing the engine 102 to produce an increased amount of excess power. In some embodiments, the controller 140 may increase the target SOC of the battery 132, when the system 100 does not include the hydrogen production system 138.

In some embodiments, the controller 140 may decrease the first hydrogen storage threshold. In some embodiments, the controller 140 may decrease the first hydrogen storage threshold responsive to receiving or determining the hydrogen production condition. In some embodiments, decreasing the first hydrogen storage threshold increases an amount of hydrogen fuel received during a “fueling event.” As described herein, a “fueling event” refers to a period of time, during which, the fuel storage device 134 receives fuel (e.g., hydrogen) from a fuel (e.g., hydrogen) source external to the system 100, such as a fueling station. For example, during a fueling event, the fuel storage device 134 may be coupled to a fueling station and receive hydrogen from the fueling station. In some embodiments, decreasing the first hydrogen storage threshold decreases an amount of hydrogen stored by the fuel storage device 134. In some embodiments, decreasing the first hydrogen storage threshold decreases an amount of hydrogen produced by the hydrogen production system 138. For example, the hydrogen production system 138 may produce hydrogen until the hydrogen storage value is at or above the first hydrogen storage threshold.

In some embodiments, the controller 140 may cause the hydrogen production system 138 to produce hydrogen based on the mission of the system 100. In some embodiments, the information regarding the mission of the system 100 may include a time period when the system 100 is stationary or determined to be stationary for a predefined amount of time. For example, the system 100 may be stationary overnight, during a fueling event, and/or other periods of time. The controller 140 may cause the hydrogen production system 138 to produce hydrogen when the system 100 is stationary and/or determined to be stationary for a predefined amount of time. The controller 140 may additionally cause the hydrogen production system 138 to produce hydrogen when the engine 102 is selectively inactivated (e.g., when the engine 102 is not producing power).

In some embodiments, when controller 140 may cause the hydrogen production system 138 to produce hydrogen based on the mission (e.g., when the system 100 is inactive), the controller 140 causes the hydrogen production system 138 to produce hydrogen until the hydrogen storage value is at or above the second hydrogen storage threshold. The second hydrogen storage threshold may be based on the mission. For example, the second hydrogen storage threshold may correspond to an amount of hydrogen required by the engine 102 to produce enough power to complete the mission (or a predefined portion thereof). The controller 140 may cause the hydrogen production system 138 to produce hydrogen responsive to the hydrogen storage value being at or below the second hydrogen storage threshold. In another example, the second hydrogen storage threshold may correspond to an amount of hydrogen required by the engine 102 to produce enough power to increase the SOC of the battery 132 at or above the target SOC and to produce enough engine 102 power to complete the mission (or the predefined portion thereof). The controller 140 may cause the hydrogen production system 138 to produce hydrogen responsive to the SOC of the battery 132 being at or below the target SOC.

The controller 140 may adjust, and, in particular, decrease the second hydrogen storage threshold when the SOC of the battery 132 is at or above the garget SOC value, thereby minimizing the amount of hydrogen in the fuel storage device 134. Advantageously, minimizing the amount of hydrogen in the fuel storage device 134 reduces a required change in the hydrogen storage value during a potential future hydrogen limiting condition (e.g., because the starting hydrogen storage value is relatively lower).

The controller 140 may adjust, and, in particular, increase the target SOC value when the hydrogen storage value is at or above the second hydrogen storage threshold. When the target SOC value increases, a portion of the hydrogen fuel may be consumed to increase the SOC of the battery 132 to meet the new, increased SOC target value. In this way, the hydrogen storage value decreases, thereby reducing the required change in the hydrogen storage value during a potential future hydrogen limiting condition (e.g., because the starting hydrogen storage value is relatively lower).

FIG. 3 is a flow diagram of a method 300 of controlling the system 100, according to an example embodiment. In particular, the controller 140 is structured to control one or more components of the system 100, such as the engine 102, the electric machine 128, and/or the hydrogen production system 138.

At process 302, the controller 140 receives an indication of a hydrogen limiting condition. Various examples of the hydrogen limiting condition are described herein with respect to FIG. 2.

At process 304, the controller 140 compares a hydrogen storage value to a hydrogen storage threshold. In some embodiments, the controller 140 may receive the hydrogen storage value from one or more sensors 125 associated with the fuel storage device 134. In other embodiments, the controller 140 may determine the hydrogen storage value based on information from one or more sensors 125. The first hydrogen storage threshold is described herein with respect to FIG. 2. As described above, the first hydrogen storage threshold may be at or below a maximum fuel storage value that is set by a government entity, a regulatory body, a business (e.g., manufacturer, operator, etc.), or other entity. Responsive to the hydrogen storage value being at or above the first hydrogen storage threshold, the method 300 proceeds to process 306 and/or process 308. Responsive to the hydrogen storage value being below the first hydrogen storage threshold, the method 300 returns to process 302 and/or ends at process 304.

At process 306, the controller 140 receives a predicted hydrogen storage value. As described above, the predicted hydrogen storage value is based on (i) an amount of excess power that the engine 102 is capable of generating before the system 100 enters the first geographic area and/or (ii) an amount of power the battery 132 can absorb.

At process 308, the controller 140 receives a predicted SOC value. The predicted SOC value is a predicted SOC of the battery when the system 100 enters the first geographic area. As described above, the predicted SOC value is based on the amount of excess power that the engine 102 is capable of generating before the system 100 enters the first geographic area.

At process 310, the controller 140 compares the predicted hydrogen storage value to the first hydrogen storage threshold. At process 312, the controller 140 compares the predicted SOC value to a predefined threshold, such as the target SOC value. Responsive to both of (i) the predicted hydrogen storage value being at or below the first hydrogen storage threshold and (ii) the predicted SOC value being at or above the SOC target value, the method 300 proceeds to process 314. Responsive to at least one of (i) the predicted hydrogen storage value being above the first hydrogen storage threshold or (ii) the predicted SOC value being below the SOC target value, the method 300 proceeds to process 316.

At process 314, in some embodiments, the controller 140 may reduce the hydrogen storage value. For example, the controller 140 may cause the engine 102 to consume at least a portion of the fuel in the fuel storage device 134. Other examples of reducing the hydrogens storage value are described herein with respect to FIG. 2. At process 308, in some embodiments, the controller 140 may reduce the amount of hydrogen produced by the hydrogen production system 138. For example, the controller 140 may decrease the target hydrogen production value, such that the hydrogen production system 138 produces a decreased amount of hydrogen.

At process 316, the controller 140 generates a new route for the system 100. As described above, it may be undesirable for the system 100 to enter the first geographic area because of a restriction or regulation on hydrogen storage within the first geographic area and/or because of the predicted SOC of the battery 132 is below the SOC threshold. The new route may correspond to a second geographic area, different than the first geographic area. The second geographic area may not correspond to a hydrogen limiting condition. In some embodiments, the second geographic area may correspond to a hydrogen production condition.

FIG. 4 is a flow diagram of a method 400 of controlling the system 100, according to an example embodiment. In particular, the controller 140 is structured to control one or more components of the system 100, such as the engine 102, the electric machine 128, and/or the hydrogen production system 138.

At process 402, the controller 140 receives an indication of a hydrogen limiting condition. Various examples of the hydrogen limiting condition are described herein with respect to FIG. 2.

At process 404, the controller 140 compares a hydrogen storage value to a hydrogen storage threshold. In some embodiments, the controller 140 may receive the hydrogen storage value from one or more sensors 125 associated with the fuel storage device 134. In some embodiments, the first hydrogen storage threshold. The first hydrogen storage threshold is described herein with respect to FIG. 2. As described above, the first hydrogen storage threshold may be at or below a maximum fuel storage value that is set by a government entity, a regulatory body, a business entity, or other entity/person (e.g., user).

At process 406, the controller 140 compares a fuel storage value of a secondary fuel (e.g., a fuel other than hydrogen) to a fuel storage threshold. In some embodiments, the controller 140 may receive the fuel storage value of the secondary fuel type from one or more sensors 125 associated with the fuel storage device 134. In some embodiments, the fuel storage value of the secondary fuel is a “predicted fuel storage value” regarding a predicted amount of the secondary fuel stored by the fuel storage device 134 when the system 100 enters the first geographic area. In these embodiments, the predicted fuel storage value is based on a fuel consumption rate of the secondary fuel between a current location of the system 100 and a location where the system 100 enters the first geographic area. In some embodiments, the fuel storage threshold may be based on an estimated amount of fuel required to traverse the first geographic area when the engine 102 consumes the secondary fuel type.

In some embodiments, responsive to the hydrogen storage value being at or above the hydrogen storage threshold and the fuel storage value regarding the secondary fuel or the predicted fuel storage value regarding the secondary fuel being at or above the fuel storage threshold, the method 300 proceeds to process 308.

In some embodiments, responsive to determining that the hydrogen storage value is at or above the hydrogen storage threshold and the fuel storage value regarding the secondary fuel or the predicted fuel storage value regarding the secondary fuel is below the fuel storage threshold, the method 300 proceeds to process 310.

At process 408, the controller 140 may reduce the hydrogen storage value. For example, the controller 140 may cause the engine 102 to consume at least a portion of the fuel in the fuel storage device 134. Other examples of reducing the hydrogen storage value are described herein with respect to FIG. 2. At process 408, in some embodiments, the controller 140 may reduce the amount of hydrogen produced by the hydrogen production system 138. For example, the controller 140 may decrease the target hydrogen production value and commands the hydrogen production system 138 to produce a decreased amount of hydrogen.

At process 410, the controller 140 generates a new route for the system 100. As described above, it may be undesirable for the system 100 to enter the first geographic area because of a restriction or regulation on hydrogen storage within the first geographic area. In other embodiments, it may be undesirable for the system 100 to enter the first geographic area because of the fuel storage value is below the fuel storage threshold (e.g., because the engine 102 may not have enough of the secondary fuel available to traverse the first geographic area). The new route may correspond to a second geographic area, different than the first geographic area. The second geographic area may not correspond to a hydrogen limiting condition. In some embodiments, the second geographic area may correspond to a hydrogen production condition.

FIG. 5 is a flow diagram of a method 500 of controlling the system 100, according to an example embodiment. In particular, the controller 140 is structured to control one or more components of the system 100, such as the engine 102, the electric machine 128, and/or the hydrogen production system 138. In various embodiments, the method 500 can be performed concurrently, partially concurrently, or sequentially with the method 300 or the method 400. In an example embodiment, the method 500 is performed before the method 300.

At process 502, the controller 140 receives an indication of a hydrogen production condition. Various examples of the hydrogen production condition are described herein with respect to FIG. 2.

At process 504, the controller 140 compares a hydrogen storage value to a hydrogen storage threshold. In some embodiments, the controller 140 may receive the hydrogen storage value from one or more sensors 125 associated with the fuel storage device 134. The second hydrogen storage threshold is described herein with respect to FIG. 2. As described above, the second hydrogen storage threshold based on a mission, a SOC target, or other factors described herein. Responsive to the hydrogen storage value being at or above the second hydrogen storage threshold, the method 500 proceeds to process 508. Responsive to the hydrogen storage value being below the second hydrogen storage threshold, the method 500 proceeds to process 512.

At process 506, the controller 140 compares the SOC of the battery 132 to the SOC threshold. In some embodiments, the controller 140 may receive the SOC of the battery 132 from battery 132 and/or from one or more sensors 125 associated with the battery 132. As described above, the SOC threshold may be an SOC target value and/or may be based on an estimated amount of charge required to traverse the first geographic area using the electric machine 128. Responsive to the SOC value being at or above the SOC threshold, the method 500 proceeds to process 510. Responsive to the hydrogen storage value being below the SOC threshold, the method 500 proceeds to process 512.

At process 508, the controller 140 increases the target SOC for the battery 132. For example, the controller 140 may increase the target SOC responsive to the hydrogen storage value being at or above the second hydrogen storage threshold. Increasing the target SOC may, for example, increase the SOC threshold used at process 506. Benefits of increasing the target SOC are described herein with respect to FIG. 2.

At process 510, the controller 140 decreases the hydrogen storage threshold. For example, the controller 140 may decrease the second hydrogen storage threshold responsive to the SOC value being at or above the SOC threshold. Benefits of decreasing the hydrogen storage threshold are described herein with respect to FIG. 2.

At process 512, the controller 140 causes the hydrogen production system 138 to produce hydrogen. For example, the controller 140 may cause the hydrogen production system 138 to produce hydrogen responsive to the SOC value being below the SOC threshold and/or response to the hydrogen storage value being below the second hydrogen storage threshold.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 140 may include any number of circuits for completing the functions described herein. For example, the activities and functionalities of the at least one processing circuit 202 may be combined in multiple circuits or as a single circuit. Additional circuits with additional functionality may also be included. Further, the controller 140 may further control other activity beyond the scope of the present disclosure.

As mentioned above and in one configuration, the “circuits” may be implemented in machine-readable medium for execution by one or more of various types of processors, such as the processor 204 of FIG. 3. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object-oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a controller comprising at least one processor coupled to at least one memory device storing instructions that, when executed by the at least one processor, cause the controller to perform operations comprising:
receiving a first indication of a hydrogen limiting condition corresponding to a first geographic area;
comparing a hydrogen storage value of a hydrogen storage system to a hydrogen storage threshold, the hydrogen storage system configured to store hydrogen fuel;
responsive to the hydrogen storage value being at or above the hydrogen storage threshold, comparing a predicted state of charge of a battery of the system to a state of charge threshold; and
causing a hydrogen combustion engine to consume at least a portion of the hydrogen fuel such that the hydrogen storage value decreases responsive to the predicted state of charge being at or above the state of charge threshold.

2. The system of claim 1, wherein the instructions, when executed by the at least one processor, cause the controller to perform further operations comprising generating a new route, responsive to determining that the hydrogen storage value is at or above the hydrogen storage threshold and the state of charge is below the state of charge threshold or will likely be below the state of charge threshold, the new route corresponding to a second geographic area, different than the first geographic area.

3. The system of claim 1, wherein the instructions, when executed by the at least one processor, cause the controller to perform further operations comprising causing the hydrogen combustion engine to provide power generated by combusting the portion of the hydrogen fuel to the battery to decrease the hydrogen storage value and increase the state of charge responsive to determining that the hydrogen storage value is at or above the hydrogen storage threshold and the state of charge is at or below the state of charge threshold.

4. The system of claim 1, wherein the instructions, when executed by the at least one processor, cause the controller to perform further operations comprising causing the hydrogen combustion engine to provide power generated by combusting the portion of the hydrogen fuel to a drive shaft to decrease the hydrogen storage value responsive to determining that the hydrogen storage value is at or above the hydrogen storage threshold and the state of charge is above the state of charge threshold.

5. The system of claim 1, wherein the instructions, when executed by the at least one processor, cause the controller to perform further operations comprising causing an electric machine to receive power from the battery such that the state of charge decreases responsive to determining that the state of charge is above the state of charge threshold and responsive to determining that the system is in the first geographic area.

6. The system of claim 1, wherein receiving the first indication of the hydrogen limiting condition is responsive to at least one of:
determining that a hydrogen concentration value received from one or more sensors exceeds a hydrogen concentration threshold;
determining that a current route of the system is within the first geographic area;
determining that a speed of the system is at or below a speed threshold; or
determining that a wind speed proximate the system is at or below a wind speed threshold.

7. The system of claim 1, wherein the hydrogen combustion engine is caused to consume the portion of the hydrogen fuel until the hydrogen storage value decreases to at or below the hydrogen storage threshold.

8. The system of claim 1, wherein the instructions, when executed by the at least one processor, cause the controller to perform further operations comprising:
receiving a predicted hydrogen storage value;
comparing the predicted hydrogen storage value to the hydrogen storage threshold;
causing the hydrogen combustion engine to consume the portion of the hydrogen fuel such that the hydrogen storage value decreases responsive to the predicted hydrogen storage value being above the hydrogen storage threshold; and
generating a new route responsive to the hydrogen storage value being at or below the hydrogen storage threshold.

9. The system of claim 8, wherein the instructions, when executed by the at least one processor, cause the controller to perform further operations comprising:
receiving an amount of power the hydrogen combustion engine is capable of generating;
determining a predicted amount of the hydrogen fuel used to generate the amount of power; and
determining the predicted hydrogen storage value based on the hydrogen storage value and the predicted amount of the hydrogen fuel used to generate the amount of power.

10. The system of claim 1, further comprising a hydrogen production system configured to produce the hydrogen fuel, wherein the hydrogen production system is coupled to the hydrogen storage system.

11. The system of claim 10, wherein the instructions, when executed by the at least one processor, cause the controller to perform further operations comprising preventing the hydrogen production system from producing the hydrogen fuel responsive to receiving the hydrogen limiting condition.

12. The system of claim 10, wherein the instructions, when executed by the at least one processor, cause the controller to perform further operations comprising causing the hydrogen production system to produce the hydrogen fuel at a first rate based on a current hydrogen consumption rate of the hydrogen combustion engine responsive to receiving the hydrogen limiting condition.

13. The system of claim 10, wherein the instructions, when executed by the at least one processor, cause the controller to perform further operations comprising causing the hydrogen production system to produce the hydrogen fuel when the system is outside the first geographic area and responsive to at least one of:
the system being stationary for a predefined amount of time; or
the hydrogen combustion engine being inactive.

14. A method comprising:
receiving an indication of a hydrogen production condition;
comparing a hydrogen storage value to a hydrogen storage threshold; and
responsive to the hydrogen storage value being below the hydrogen storage threshold and responsive to receiving the indication of the hydrogen production condition, causing a hydrogen production system to produce hydrogen fuel;
wherein the hydrogen production system is on a vehicle.

15. The method of claim 14, further comprising increasing a state of charge target value for a battery of the vehicle responsive to the hydrogen storage value being at or above the hydrogen storage threshold.

16. The method of claim 14, further comprising:
comparing a state of charge value of a battery to a state of charge threshold; and
causing the hydrogen production system to produce the hydrogen fuel responsive to the state of charge value being below the state of charge threshold.

17. The method of claim 16, further comprising causing an engine of the vehicle to consume at least a portion of the hydrogen fuel responsive to the state of charge value being at or above the state of charge threshold.

18. The method of claim 14, wherein the hydrogen production system is caused to produce hydrogen fuel until the hydrogen storage value is at or above the hydrogen storage threshold.

19. A hydrogen engine system, comprising:
a controller comprising a communications interface and at least one processor coupled to at least one memory device storing instructions that, when executed by the at least one processor, cause the controller to perform operations comprising:
receiving, via the communications interface, a first indication of a hydrogen limiting condition corresponding to a first geographic area;
comparing a hydrogen storage value of a hydrogen storage system to a hydrogen storage threshold, the hydrogen storage system configured to store hydrogen fuel;
comparing a fuel storage value of a fuel storage system to a fuel storage threshold; and
causing a dual-fuel combustion engine to consume at least a portion of the hydrogen fuel whereby the hydrogen storage value decreases responsive to determining that the hydrogen storage value is at or above the hydrogen storage threshold and that the fuel storage value is at or above the fuel storage threshold.

20. The hydrogen engine system of claim 19, wherein the instructions, when executed by the at least one processor, cause the controller to perform further operations comprising generating a new route, responsive to determining that the hydrogen storage value is at or above the hydrogen storage threshold and the fuel storage value is at or below the fuel storage threshold, the new route corresponding to a second geographic area, different than the first geographic area.
